(19) United States
(12) Patent Application Publication
(10) Pub. No.: US 2006/0037660 A1
(43) Pub. Date: Feb. 23, 2006

(54) Hydrogen conduit and process for producing same

(76) Inventors: Kevin J. Kinnally, Stanwood, MI (US); Lennart J. Johansson, Saline, MI (US)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(21) Appl. No.: 11/209,133

(22) Filed: Aug. 22, 2005

Related U.S. Application Data
(60) Provisional application No. 60/603,451, filed on Aug. 20, 2004.

(51) Int. Cl. F16L 9/14; B21C 23/24

(52) U.S. Cl. 138/143; 138/146; 72/47

(57) ABSTRACT

A conduit for conveying hydrogen under conditions of high temperature and high pressure comprises a clad, seamless tubing having a substrate layer formed of a tough base material that includes iron, chromium, or nickel, or alloys thereof. The tubing further has a thin cladding or surface layer formed of an alloy including at least about 2-10% aluminum, combined with other materials that include at least one of iron and nickel and chromium, in an amount sufficient to make the surface layer capable of resisting hydrogen permeation. The conduit is formed by draw bonding a cladding tube in the substrate tube.

### CROSS REFERENCE TO RELATED APPLICATIONS

This application is based on and claims the benefit of the filing date of Applicant's copending provisional application No. 60/603,451, filed Aug. 20, 2004, the disclosure of which is incorporated herein by reference.

### BACKGROUND OF THE INVENTION

A great deal of research and development has been undertaken in order to develop alternative fuels to petroleum. Hydrogen is one of the more promising fuels, because the supply is limitless and the byproduct is nonpolluting water. Hydrogen, however, has its own problems. Hydrogen is the lightest element and is extremely difficult to contain and store. Hydrogen is so volatile that it permeates and passes through some metals and causes other metals to become brittle.

Some metals are known to be less subject to hydrogen embrittlement and to be less permeable than others. Sometimes conduit is made of these metals, which are often expensive, exotic metals. In other cases, materials resistant to hydrogen permeation have been applied as a coating to more conventional tubing.

Materials used for the direct flame tubes of an external combustion heat engine, such as a so-called Stirling engine, have additional requirements that make it difficult to develop and produce completely satisfactory tubing. These include good heat transfer properties across the boundary between layers of a multilayer tube, minimum diffusion of components of one layer into another layer, the capability of withstanding high pressure and heat (above 700° C. and 5,000 psi), and resisting hydrogen permeation and hydrogen embrittlement under those conditions.

An object of the present invention is to provide a metal conduit for conveying hydrogen under conditions of high temperature and pressure while providing low hydrogen permeability and desirable heat transfer properties in a tube that is relatively cost effective to manufacture.

### SUMMARY OF THE INVENTION

In accordance with the present invention, conduit for conveying hydrogen under conditions of high temperature and high pressure comprises clad, seamless tubing having a layer formed of a tough, relatively inexpensive base material that includes steel or nickel or alloys thereof, and a relatively thin surface layer formed of an alloy including at least about 2% and preferably about 3-6% aluminum (or more), preferably combined with iron and chromium, and preferably yttrium, in an amount sufficient to make the surface layer capable of resisting hydrogen permeation and withstanding temperatures of at least about 700° C. and pressures of at least 5000 psi. The aluminized layer is pre-oxidized if it is not subject to oxidation during use.

A process for producing this tubing includes forming inner and outer tubular layers and then mechanically bonding the tubes together in a draw bonding process that produces a single tube having two (or more) layers. This process is capable of producing fine, thin walled hydrogen conduit having an outside diameter as small as about 2.36 mm and an inside diameter as small as about 1.37 mm.

These and other features and advantages of the present invention are described in detail below and shown in the appended drawings.

### BRIEF DESCRIPTION OF THE DRAWINGS

FIG. 1 is a perspective view of a section of tube constructed in accordance with the present invention.

FIG. 2 is a cross-sectional view of the tube of FIG. 1.

FIG. 3 is a schematic illustration showing the manufacture of a clad tube employing a draw bonding technique.

### DETAILED DESCRIPTION OF PREFERRED EMBODIMENT

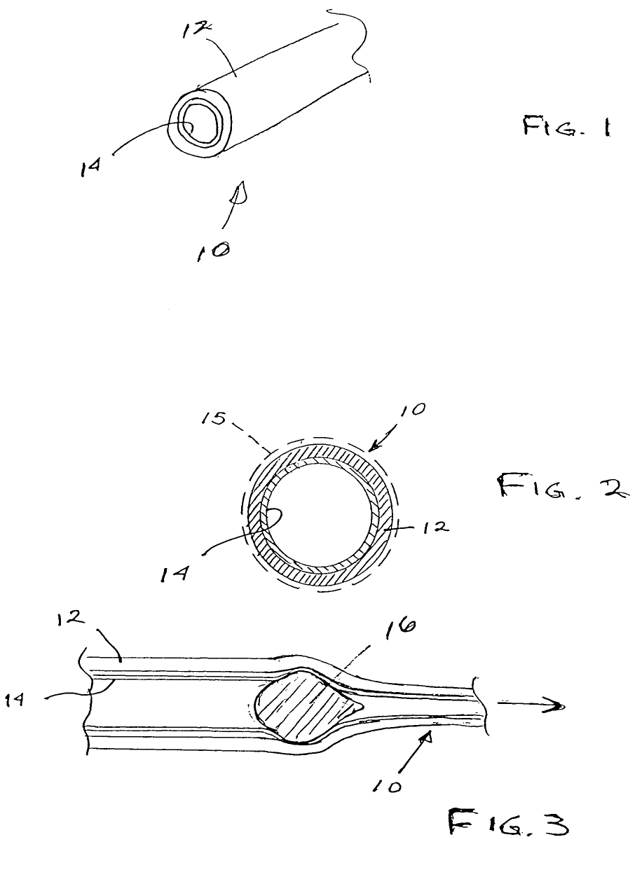

Referring now to the drawings, a hydrogen conduit formed in accordance with the present invention is shown in FIGS. 1 and 2, and the process for forming the conduit is shown in FIG. 3.

As shown in FIG. 1, conduit or tube 10 has an outer layer 12 and an inner layer 14. Outer layer 12 is called the base layer or structural layer or substrate, while inner layer 14 is called the cladding layer. While a tube clad on the inside is satisfactory for most purposes, the cladding can be applied to the outside instead of the inside in some circumstances, and in other circumstances, the cladding can be applied to both the outside and the inside. Exemplary exterior cladding 15 is shown in phantom in FIG. 2. Additional layers of additional materials are not precluded and can be employed if desired.

In one application of the present invention, the tubing is employed for conveying hydrogen under conditions of high heat and pressure in a heat engine commonly known as a Stirling engine, which is an external combustion engine that has been known for almost two centuries but has been used in only limited applications to date. The Stirling engine still poses a number of development difficulties but promises high efficiency if the development problems can be overcome.

While the detailed description in the present application is limited to the Stirling engine, the tubing of the present invention can be used in other applications, such as in a hydrogen fuel cell and in a fusion reactor, which employs radioactive hydrogen isotopes, such as tritium. The present invention can also be used for turbines and for chemical processing and in heat treating applications, because of its outstanding oxidation, sulfidation, and carburization resistance. This clad tubing also provides resistance against water vapor enhanced oxidation found in high temperature exhaust systems, salt and coal ash corrosion, and chlorine containing atmospheres. Another application is incineration systems.

The base layer 12 of the present invention can be formed of a number of materials, preferably a nickel alloy known as alloy 625 and sold under the brand name Inconel. Other superalloys also are satisfactory. The base layer of the tube can also be an austenitic stainless steel tube, such as 347H or 20-25 Nb, or austenitic stainless steel alloys, such as HR120 or 803. A base layer of HR230 or other alloy with more temperature capability can be desirably employed for applications above 800-850° C. Other alloys providing strength at a cost effective price could be employed. For a direct flame tube heat engine application, the base layer tube may be about 4.76 mm in outer diameter, with a wall thickness of about 0.635 mm. These dimensions can vary for different applications.

Cladding layer 14 is an aluminum-containing alloy or compound, preferably an aluminum-containing ferritic chromium steel alloyed with yttrium, referred to as a FeCrAlY alloy. Aluminum comprises at least about 2% to 10% or more, desirably at least about 3-6%, and preferably about 5.5 to 6.0% of the composition. The addition of a small amount of hafnium, in addition to yttrium, is desirable because it enhances the formation, stability, and spallation resistance of the alumina scale that forms on the outside surface of the cladding layer. A product formulated with this composition is commercially available under the trade name ALUCHROM YHf. This product includes about 0-0.30% nickel; 19-21% chromium; 0-0.05% carbon; 0-0.050% manganese; 0-0.050% tin; 5.5-6.0% aluminum; 0-0.07% zirconium; 0-0.1% yttrium; 0-0.1% hafnium; and 0-0.01% nitrogen, with the balance (about 70%) being iron. The cladding layer preferably has a wall thickness of about 3-10 mils (0.0762-0.254 mm).

Other aluminum alloys or compounds containing higher levels of aluminum, perhaps as high as 50% could work if they were commercially available and were sufficiently formable.

The base tube and cladding tube layers preferably are formed first as seamless tubes. The cladding tubes can be formed from existing sheet stock in a conventional tube forming operation. This can involve roll forming the sheet stock into a tube and then welding to fuse the longitudinal seam.

An important feature of the present invention is the manner in which the cladding is applied to the base tube. Because of the extremely high heat environment during use (at least 700° C.), it is important that the tube withstand high temperature and possess good heat transfer characteristics across the boundary between the layers. Thus, the bond between the layers must be very good. Poor heat transfer characteristics detract from the efficiency of the tube as a heat exchanger and can make the alumina scale on the tube subject to spalling, which can damage the engine. Moreover, the cladding surface on the interior of the base tube must be uniform in order to provide adequate resistance against hydrogen permeation. Because of these requirements, and because of the fine, thin nature of the tubing, most conventional methods for applying a cladding to tubing are inadequately effective.

In the present invention, the cladding is preferably applied to the base tube by means of a process known as draw bonding. In this process, the cladding and base layers are formed as separate tubes. The tubes are then positioned concentrically and drawn simultaneously over a mandrel 16. The action of pulling or drawing the tubes over the mandrel causes the tubes to stretch and collapse onto one another, forming a tight mechanical bond between the cladding and base tube layers that is then transformed into a metallurgical bond during recrystallization. Because the tube is formed by drawing and not by a heating process, the problem of melt back or diffusion of one layer into the other is minimized with the present application. Also, because the amount of aluminum in the cladding layer is relatively low, there is a lowered likelihood of the aluminum diffusing into the base layer of the tube.

The draw bonding process for producing the cladding of the present invention provides important advantages, which are especially prominent for the narrow dimensions and high performance requirements for direct flame tube application. These benefits include ease of initial application, adapatability of the product for subsequent operations (such as vacuum braising), the superior hydrogen permeation barrier properties of the product at elevated temperatures and pressures, and the relative cost effectiveness of the product. The use of an aluminum alloy with enough aluminum (e.g., 3-6 weight percent) easily forms a continuous, thin, compact, adherent (resistant to spallation), oxide film during pre-oxidation after tube fabrication and also remains stable during vacuum braising and engine operation. Some other oxides can evaporate in a vacuum and certainly would not form. Moreover, high temperature hydrogen is a highly reducing environment that can remove unstable oxides. The present invention avoids these problems.

In one exemplary embodiment of the present invention, an interior cladding formed of an FeCrAlY alloy, sold under the brand name ALUCHROM, is applied to a seamless alloy 625 (Inconel) tube by draw bonding. The base layer is formed as a tube about 4.76 mm inches in outer diameter, with a wall thickness of about 0.635 mm. The inner or cladding layer is formed from flat stock into a tube thin enough to fit inside the outer tube, with a wall thickness of about 0.254 mm. The cladding tube is positioned inside the base tube and the tubes are draw bonded over a mandrel to a final outside diameter of 4.76 mm and inside diameter of 2.98 mm. The draw bonding produces a metallurgical bond between the layers and subsequent annealing recrystallizes the metal affected by the seam welding or fusing, such that the final product is a fine integral multilayer tube having a uniform aluminum inner layer and good heat transfer properties. Indeed, the heat transfer properties of the composite tube are believed to be better than a tube formed of alloy 625 alone.

When the cladding layer on the tube is pre-oxidized, a thin, adherent aluminum oxide scale forms on the surface. This scale provides the resistance to hydrogen permeation.

While the use of a FeCrAlY alloy (such as ALUCHROM YHf) is preferred, other alloys or compounds can be used. Another cladding alloy that has satisfactory properties is HR 214, which is a nickel based alloy containing about 16% chromium and about 4% aluminum. Other alloys or compounds that withstand temperatures of at least 700° C. and include at least about 2% aluminum are within the scope of the present invention.

Also, other exterior or base layer alloys can be used instead of alloy 625. Stainless steels and similar, tough, corrosion resistant and relatively cost effective materials can be used.

The process of draw bonding produces a good quality tube cost effectively. Most other processes used for applying a protective cladding on a tube are not satisfactory for the requirements of the present invention (a uniform, thin cladding on the interior of a fine, narrow diameter tube). This is not to say that draw bonding is the only process that can work. A precise vapor-phase aluminizing process can also be used to apply an aluminum coating on the interior (and exterior) of a fine tube. An aluminum cladding formed in this way and pre-oxidized also demonstrates reduced hydrogen permeation. A potential drawback with a cladding layer having a high percentage of aluminum is that the aluminum might diffuse into the base layer and change the metallurgical-characteristics of that alloy. The use of FeCrAlY or HR 214 or equivalent as a thin, internal, draw bonded cladding minimizes the risk of detrimental diffusion.

One of the novel benefits of applying the cladding by draw bonding is that ambient or lower temperature deformation of clean surfaces forms a mechanical bond through high deformation at the joint surfaces. This bond then transforms to a metallurgical bond during recrystallization annealing at higher temperatures, with enough diffusion to accomplish this bonding, but not so much that it diminishes the properties of the base tubing alloys.

While the clad tubing of the present invention and the method of forming the same have particular advantages in direct flame tubes in Stirling engines, the tubing can also be used in other tubing applications having similar tube requirements. The tubing also is useful where it is desired to have superior corrosion resistance to oxidation, moisture-enhanced oxidation, sulfidation, carburization (and coking and metal dusting). Such tubing can have application in a heat exchanger or containment application that does not involve Stirling engines or hydrogen.

Experimental testing with pre-oxidized aluminum cladding on base metal tubing (inside alone or inside and outside) confirms a very substantial reduction in hydrogen permeability. Using a testing scale wherein a badly leaking tube has a permeation factor of 1000 and a perfect tube has a permeation factor of 0, a brand new Inconel 625 tube has a permeation factor of 700. The permeation factor drops to 40-50 once use of the tube is commenced in an engine. Some doping methods can reduce the permeation factor of the 625 tube to 25-40. A thin protective layer of aluminum oxide produced by pre-oxidizing a thin aluminum-containing cladding layer reduces the permeation factor to about 4 to 8, and sometimes lower. Moreover, a thin cladding layer of roll bonded FeCrAlY can have heat transfer properties that are better than alloy 625 alone.

While a draw bonded tube comprising a cladding utilizing an aluminum alloy or compound produces superior resistance to hydrogen permeation, as well as good heat resistance and good heat transfer properties, draw bonding also produces desirable results with other cladding materials. For example, the use of alloy 230 (HR 230) as a cladding as a draw bonded cladding inside alloy 625 produces good corrosion resistance and improved hydrogen permeation properties in a tube having heat transfer properties comparable to alloy 625 alone.

It should be recognized that the foregoing is merely exemplary of the preferred practice of the present invention and that various changes in the details of the products and processes described herein may be made without departing from the spirit and scope of the present invention.

I claim:

1. Conduit for conveying hydrogen under conditions of high temperature and high pressure, the temperature being at least about 700° C. and the pressure being at least as high as 5000 psi, the conduit comprising a clad, seamless tubing having a layer formed of a tough base material that includes iron, chromium, or nickel, or alloys thereof, the tubing further having a thin surface layer formed of an alloy including at least about 2-10% aluminum combined with other materials that include at least one of iron and nickel and chromium, in an amount sufficient to make the surface layer capable of resisting hydrogen permeation.

2. A conduit as in claim 1 wherein the cladding is oxidized so as to form a thin aluminum oxide layer on the tube.

3. In a so-called Stirling engine employing a direct flame tube for an engine heater head, the improvement wherein the direct flame tube comprises a fine, narrow diameter clad metal tube that includes a tubular base layer and a relatively thin tubular cladding layer, the cladding layer being formed of an alloy including aluminum and chromium and one or more of iron and nickel, with the aluminum comprising at least about 2% of the cladding layer, the layers being mechanically bonded together so as to provide good heat conduction through the layers, the base layer providing strength for the tube while the surface layer provides increased resistance to hydrogen permeation.

4. A Stirling engine direct flame tube as in claim 3 wherein the tube base layer has an outer diameter of about 4.76 mm and has a wall thickness of about 0.675 mm, the cladding layer having a wall thickness of about 0.0254 mm and being positioned inside the base layer, the tube layers being mechanically bonded together by orientating the tubes concentrically and draw-bonding them together.

5. A thin wall, small diameter tube of a size appropriate for a direct flame tube for a Stirling engine heater head, comprising a clad tube formed of at least two layers, one layer being a relatively thick layer formed of a metal that includes stainless steel, a stainless steel alloy, a nickel alloy, or other superalloy, and the other layer being a relatively thin layer formed of an alloy including iron, chromium, and aluminum, with the aluminum comprising at least about 2% of the alloy composition.

6. A process for forming a thin clad tube capable of resisting hydrogen permeation under conditions of high temperature and pressure comprising:
providing a substrate tube;
providing at least one cladding tube that fits concentrically with respect to the substrate tube, the cladding tube comprising an alloy including aluminum and chromium, and one or more of iron and nickel, with the aluminum comprising at least about 2% of the composition; and
draw bonding the tube into a composite clad tube by drawing the tube over a mandrel.

7. A process according to claim 6 wherein the cladding is pre-oxidized at least to the extent that the cladding is not expected to be exposed to oxygen during normal use of the tube.

8. A process according to claim 5 wherein the aluminum comprising about 3-6% of the cladding tube alloy.
